(19) United States
(12) Patent Application Publication
(10) Pub. No.: US 2015/0227992 A1
(43) Pub. Date: Aug. 13, 2015

(54) Building Optimization Platform And Web-Based Invoicing System

(71) Applicant: GENEA ENERGY PARTNERS, INC., Irvine, CA (US)

(72) Inventors: Michael Wong, Newport Beach, CA (US); Keith Voysey, Yorba Linda, CA (US)

(21) Appl. No.: 14/696,276

(22) Filed: Apr. 24, 2015

Related U.S. Application Data
(63) Continuation-in-part of application No. 13/906,115, filed on May 30, 2013.
Application No. 13/906,115 is a continuation of application No. 12/853,240, filed on Aug. 9, 2010, now abandoned.
Application No. 12/853,240 is a continuation of application No. 11/941,582, filed on Nov. 16, 2007, now Pat. No. 7,774,245.
(60) Provisional application No. 60/859,802, filed on Nov. 16, 2006.

(51) Int. Cl. G06Q 30/04; G06Q 50/06; G06Q 30/02; G06Q 50/16; G06Q 30/06

(52) U.S. Cl. CPC G06Q 30/04; G06Q 50/163; G06Q 30/0645; G06Q 30/0283; G06Q 50/06

(57) ABSTRACT

A building management and optimization system and method are disclosed. An asset tag can be physically associated with a submeter that may not be connected with a communication network. The submeter can be configured to track and measure consumption of a utility service associated with a tenant occupying at least part of a building in accordance with a lease. The consumption can be an instance of a tenant-incurred cost of above standard tenant services use. A mobile computing device can have a reader for reading the encoded representation of the physically associated submeter and can receive an input signal representing a meter reading of the associated submeter. An application for execution on the mobile computing device can receive an identity of the associated submeter and the meter reading and determine whether the meter reading is valid. Related apparatus, systems, techniques, and articles are also described.

### CROSS REFERENCE TO RELATED APPLICATION

This application is a continuation-in-part and claims the benefit of priority under 35 U.S.C. §120 of co-pending U.S. patent application Ser. No. 13/906,115, filed May 30, 2013, entitled “Building Optimization Platform And Web-Based Invoicing System”, which is a continuation of U.S. patent application Ser. No. 12/853,240, filed Aug. 9, 2010, entitled “Building Optimization Platform And Web-Based Invoicing System”, which is a continuation of U.S. patent application Ser. No. 11/941,582 (now issued as U.S. Pat. No. 7,774,245), filed Nov. 16, 2007, entitled “Building Optimization Platform And Web-Based Invoicing System”, which claims priority under 35 U.S.C. §119 to U.S. Provisional Application Ser. No. 60/859,802, filed Nov. 16, 2006, entitled “Afterhours Control System”. The disclosures of these applications are incorporated herein by reference in their entirety.

### BACKGROUND

This disclosure relates generally to optimizing services for buildings, and more particularly to a system and method for automated management of energy-related building services.

Energy is the single highest expense incurred by property owners of buildings, and this expense is projected to grow dramatically over the next several years. According to a Nov. 25, 2005, Federal World Energy Study, energy costs are projected to double the rates used 15 years ago, exceeding $59.5 trillion annually. Off-peak electrical rates average $0.14/kWh and Peak rates can reach $2.40/kWh. When energy use is allowed to go unchecked, rolling blackouts can result. During peak hours, utility companies may even impose structured outages, known as “brownouts,” and many energy companies are now proposing huge penalties for lack of controlled usage of building services such as energy services.

With the advent of digital controls to replace pneumatic controls for both new and existing buildings, several controls manufacturers have been digitizing the physical infrastructure of buildings. As energy demands and environmental concerns increase, states including California have instituted building efficiency standards (Title 24) to accelerate this digitization of building infrastructure in an effort to increase energy efficiency and reduce greenhouse gas emissions. In addition, tenants, building managers, and building owners are all proactively searching for solutions to address these concerns as they relate to buildings.

A common problem set faced by all building owners, managers or even tenants include lost revenue, wasted energy, operational inefficiencies, and lack of accountability. Historically, commercial tenants who have no limits or accountability imposed on them during operating hours waste the most energy. Further, there is significant consolidation occurring in ownership of buildings, yet building owners with large portfolios experience disparate energy management systems, property managers and building engineers.

In many commercial buildings, tenants usually maintain a room that houses equipment such as one or more server computers or mainframe databases, for example. These rooms are often referred to as “server rooms.” Such equipment must be cooled by heating ventilation air conditioning (HVAC) 24 hours per day. This type of equipment is known as “supplemental equipment,” and the energy required to maintain it, such as continuous HVAC and other electrical services, is typically above and beyond the energy services allowed or covered by the tenant's lease. These additional energy services are known as “above standard tenant services” because it represents energy services that the tenant must pay for in addition to its regular lease payment, which often includes a threshold amount of energy services.

Energy services for supplemental equipment are typically tracked by one or more submeters. Most legacy submeters are not networked with a building's energy management system (EMS). Thus, in order to bill for energy services used for supplemental equipment, an agent of a property management company typically visits each submeter on a regular basis and manually read and collect the meter reading, and then manually generate a spreadsheet invoice for each submeter. This process is manual, time-consuming and inefficient, and subject to human error at every step in the process. Further, such process lacks transparency and accountability for tenants.

### SUMMARY

In general, this document discusses web-based systems and methods for managing and optimizing energy-related building services for buildings. These systems and methods can improve net operating income of a building, and therefore dramatically increase the underlying property value of the building, particularly for the building owner. In particular, this document describes an automated meter reading and billing system and method.

According to one aspect, an asset tag is physically associated with a submeter that is not connected with a communication network. The submeter is configured to track and measure consumption of a utility service associated with a tenant occupying at least part of a building in accordance with a lease covering at least some utility service used by the tenant as part of standard tenant services. The consumption of the utility service is an instance of a tenant-incurred cost of above standard tenant services use. The tenant-incurred cost is determined based on usage data in excess of that covered by the lease in the at least part of the building. The asset tag has an encoded representation of the physically associated submeter. A mobile computing device having a reader reads the encoded representation of the physically associated submeter within the at least part of the building. The mobile computing device receives an input signal representing a meter reading of the associated submeter based on the measured consumption of the utility service by the submeter. An application for execution on the mobile computing device receives an identity of the associated submeter and the meter reading of the associated submeter and determines whether the meter reading is valid based on a comparison of the consumption associated with the meter reading with one or more historical consumption values.

The above methods, apparatus, and computer program products may, in some implementations, further include one or more of the following features.

The application can be further configured to display a user notification based on the determining.

The application can be further configured to store the meter reading in a database having the one or more historical meter reading values.

The application can be further configured to generate a visual representation of the one or more historical meter reading values.

The utility service can be associated with one or more of supplemental equipment usage, plug load usage, water usage, steam usage, and natural gas usage.

The application can be further configured to receive an image for the meter reading and save the image to a database. The image can be used to audit the meter reading.

The meter reading of the associated submeter can be used to generate an invoice for the consumption of the utility service as tracked and measured by the submeter.

The asset tag can include a machine-readable indicia selected from one or more of a QR code, a bar code, a graphical code, and an alphanumeric code.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a functional block diagram of a building optimization platform.

FIG. 2 illustrates a building services management system.

FIG. 3 is a flowchart that illustrates a web-based invoice approval process for energy-related building services.

FIGS. 4A-H are exemplary screenshots of a graphical user interface to illustrate an implementation of web approval process of invoices for above standard services.

FIGS. 5A-C show exemplary statements having detailed billing information for building services.

FIGS. 6A-D show exemplary variance reports generated from business intelligence on invoicing information.

FIG. 7 illustrates an automated meter reading and billing system.

FIG. 8 is a flowchart that illustrates an automated meter reading and billing process.

FIG. 9 is a flowchart that illustrates an automated meter reading and billing process as implemented by a computer.

FIGS. 10A-E are exemplary graphical user interfaces displayed by an application associated with the automated meter reading and billing system.

Like reference symbols in the various drawings indicate like elements.

### DETAILED DESCRIPTION

This document describes a computer-implemented building optimization platform for buildings, such as multi-tenant office buildings. The platform utilizes automated, web and telephony-based building services management tools to control, account, and manage building services, to address lost revenue, wasted energy, operational inefficiencies, and previous lack of accountability for energy-related building services used by tenants.

The building optimization platform enables building owners and property managers to invoice tenants for above standard tenant services, i.e., any building service such as energy services that falls outside a normal tenant lease. Examples of above standard tenant services include, without limitation, a tenant's use of energy-related building services during non-lease hours or beyond agreed-upon levels—in other words, for energy services use that exceeds an amount, duration, or timeframe that are contractually covered by the tenant's existing lease. The building optimization platform can track consumption premised upon metered use values to allocate costs to tenants of a building.

The web-based approval process includes energy-related building services such as after hours HVAC, after hours lighting, tenant plug load usage, tenant equipment usage (such as HVAC equipment for cooling tenant-specific areas or equipment), and for tenants that pay for their own utilities, accelerated depreciation of mechanical equipment. The building optimization platform tracks and invoices for the following: source of after hours request, time of after hours request (billable or nonbillable event), type of after hours request (lighting only, or both lighting and HVAC), duration of request, billing rates (consolidated, split, flat, tiered, and/or metered), aggregate value of invoices currently unbilled, and/or common points concurrently used that may provide split billing.

The building optimization platform works in several key ways to address lost revenue, wasted energy, operational inefficiencies, and lack of accountability that afflicts most office buildings. The building optimization platform communicates with the building at a physical infrastructure level by overlaying onto the building's existing energy management system (EMS) and hardware. The building optimization platform also automates many of the complicated and manual building management processes used by owners, property managers, accountants, building engineers, and tenants, and integrates into the building owner's or property manager's accounting or ERP system. The building optimization platform further provides on-demand capability for tenants via a web browser, phone, or PDA that allows them to request, schedule, and manage their own energy-related building services.

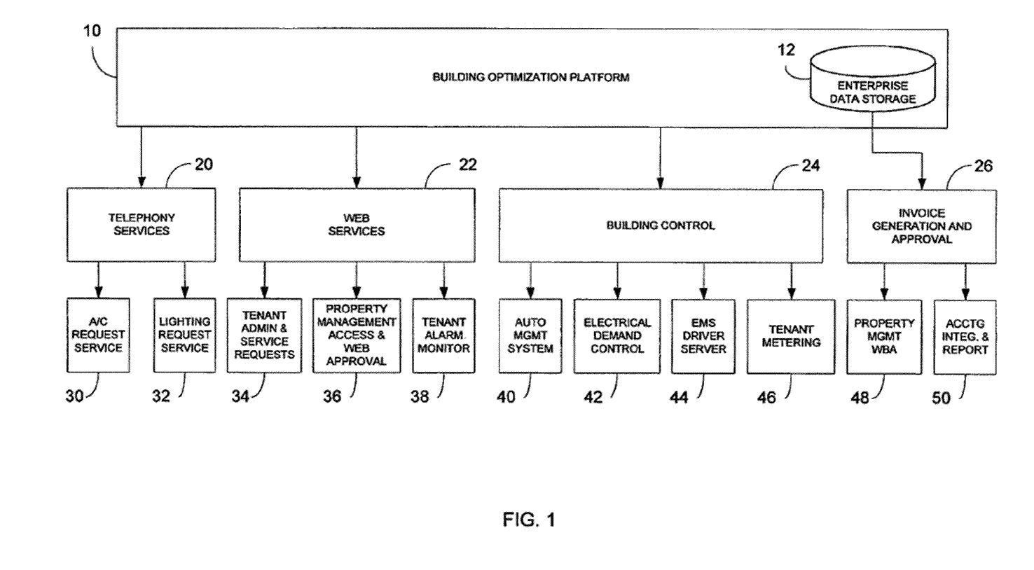

FIG. 1 is a functional block diagram of a building optimization platform 10 for managing business processes, implemented and executed as a set of services, to optimize building services for buildings. The building optimization platform 10 includes an enterprise data storage 12, business processes of telephony services 20, web services 22, building control services 24, and accounting and invoice generation services 26.

The telephony services 20 are managed and controlled by a telephony server, and include A/C request services 30 and lighting request services 32, which together with other control functions of the building optimization platform 10 enables remote tenant access (via phone and/or internet) which allows tenants to use after hours (i.e. hours within a day or on weekends that are not covered by a tenant lease or other contractual obligation to the tenant) air conditioning and lighting for a fee, and provides property owners/managers with automated tracking and billing.

The A/C request services 30 and lighting request services 32 include telephony interface with a server that is part of the building optimization platform 10, which enables any tenant to request above-standard energy-related building services via commands input into a telephone. The requests are automatically captured by the server and provided to accounting and invoice generation services 26, as will be described in further detail below. Accordingly, the combination of telephony services and invoice generation and web approval services enables tenants, property managers and system administrators to accurately monitor, track, invoice and monetize above standard services provided to requesting tenants.

The web services 22 enable web-based access to and management of after hours services and automated billing using an application service provider (ASP) modeled server system. Web services 22 include tenant administration and service requests 34, and tenant alarm monitoring 38. Web services 22 also implements an automated process of tenant metering and to provide a web-based management approval process 36 for invoices, services, etc.

Building control services 24 are hosted in a server system and controlled by building optimization platform 10 based on input executed through web services 22 and telephony services 20. Building control services 24 includes an Energy Management System (EMS) driver server 44 that includes interface software for interacting and controlling a number of different EMS control systems made by various EMS manufacturers and open protocols, such as BACNET, Lonworks, Modbus, etc. The EMS driver server 44 is preferably implemented utilizing remote procedure call (RPC) enabled building connectivity. Building control services 24 also includes an automated management system (AMS) 40, a server and web-based SaaS-modeled control system that utilizes advanced energy services control algorithms to constantly monitor and adjust a building's HVAC system to achieve the lowest possible energy consumption, and system administration and property management 46.

Building control services 24 also implements Electrical Demand Control 42 for Peak Demand Limiting/Demand Response. Peak Demand Limiting provides constant monitoring of the building's electric load for the highest periodic power consumption to confine and limit demand, which results in lower utility bills, utility rebates and incentives to transfer to a more preferred rate schedule, and also reduces the ratcheting effect of annual peak charges. Tenant Metering 46 provides reading, tracking and billing services for advanced tenant billing for above standard tenant services. Consumption outside lease hours, over allotted lease allowance, peak charges, and maximum peak as well as supplemental equipment metering are tracked and invoiced by building control services 24.

Account and invoice generation services 26 includes property management web based approval process 48 and accounting integration and reporting 50, which are explained further below.

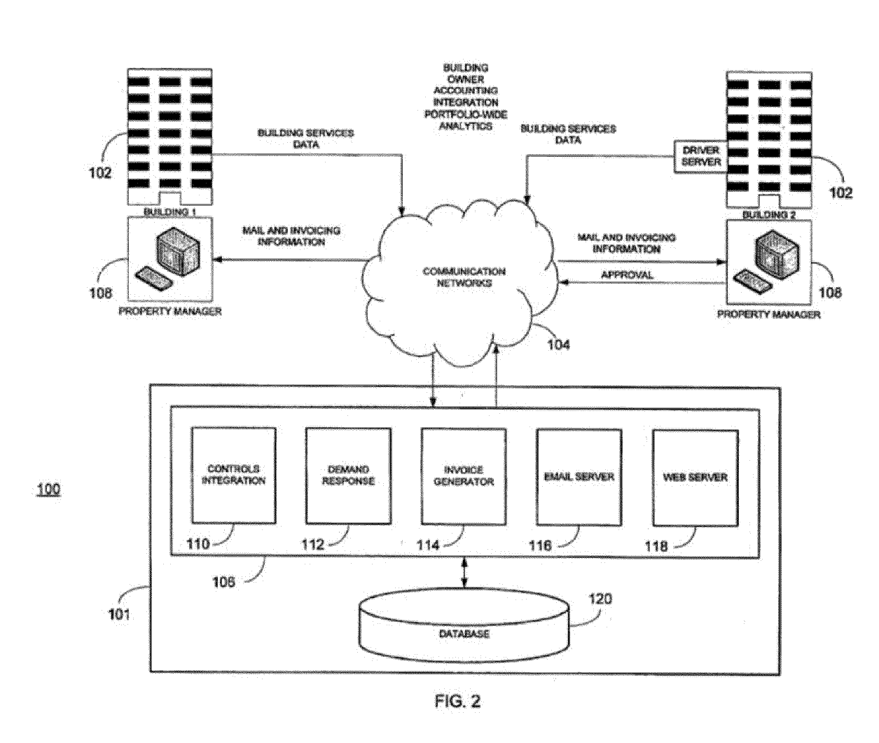

FIG. 2 illustrates a building management system 100 that includes a building optimization platform 101 for managing, controlling, and optimizing building services via business processes implemented as a set of services. The building optimization platform 101 includes a first communication interface that is adapted to receive building services data from one or more buildings 102 via a first communication network 104. The building optimization platform 101 further includes a server system 106 that generates invoicing information for building services used at the buildings 102 based on the building services data, and transmits the invoicing information in an electronic invoice through a second communication interface. The invoicing information is accessible and approvable through a user interface of a client computer 108 connected to the server system 106 via a second communication network 104.

The building services data is preferably generated by one or more energy management systems (EMSs) located throughout each building 102. Each EMS includes digital sensor and control hardware and software that is built and installed by any number of third party vendors. The EMSs monitor building services use or consumption, such as lighting and A/C systems, at various locations within the building 102, and communicate the use data via the first communications network 104, which can include one or more wireless communication networks, and operating according to one or more open protocols, such as BACNET, Lonworks, Modbus, etc.

The building management system 100 can include a driver server 103 that can be used to connect to a network of EMSs within a building. Server system 106 preferably communicates using XML—driver server 103 translates XML data into serial data used by EMS Can reside on a separate PC, a workstation, or need not be used at all. Allows connectivity, if necessary, to an EMS depending on the EMS type. Hosts one or more drivers for each EMS used in the building.

The building services data is received and processed by a controls integration module 110 in the server system. A demand response module 112, as part of an automated management system at the server system 106, monitors the building services data and can control building services, such as fulfilling after hours lighting requests, limit energy consumption during peak demand periods, etc.

The server system 106 includes an invoice generator 114 that generates an electronic invoice for each tenant of each building 102. The electronic invoice includes invoice template information and tenant information that is stored for each tenant in a database 120. The tenant information can be entered into the database manually, during a setup process. The electronic invoice is generated regularly, preferably on a periodic basis such as monthly. The electronic invoice represents an invoice for “above standard tenant services”—any service that falls outside a normal lease for the tenant.

Once the electronic invoice is generated, it is posted to web server 118. An electronic message is then generated by email server 116 and sent to the client computer 108, which is typically used by a property manager associated with at least one building 102. The electronic message contains a notification of the availability of the electronic invoice, as well as a hypertext link to the electronic invoice stored either in the database 120 or on web server 118. Once a user of the client computer 108 selects the relevant link, the web server 118 transmits a log-on page in which the property manager can gain access to a building services website in which the property manager can manage all energy-related tenant services.

The building services website includes one or more web pages containing the electronic invoice that can be displayed in a user interface of the client computer 108, such as a browser application used by the client computer 108. The electronic invoice can be generated in HTML or XML, and delivered through communication network 104 by any one of a number of communication protocols, including HTTP.

The email server 116 can also be configured to generate and send confirmation emails to tenant for services they request. For example, if a tenant requests 500 hours of afterhours lighting services, the email server 116 generates an email which automatically is sent to the tenant, tenant office manager, property manager and/or system administrator to confirm requesting tenant, the type of services requested, duration, and date, among other possible information. The email server is linked with and provides the invoice generator 114 with the request information for invoice generation.

Acknowledgements of the confirmation emails are processed by the demand response module 114 of the server system 106, or other control server. Changes to requests, later declines of requests, or any other changes can be executed by the tenant or responsible party clicking on a link in the confirmation email to reach the demand response module 114 of the server system 106 of the building optimization platform 101.

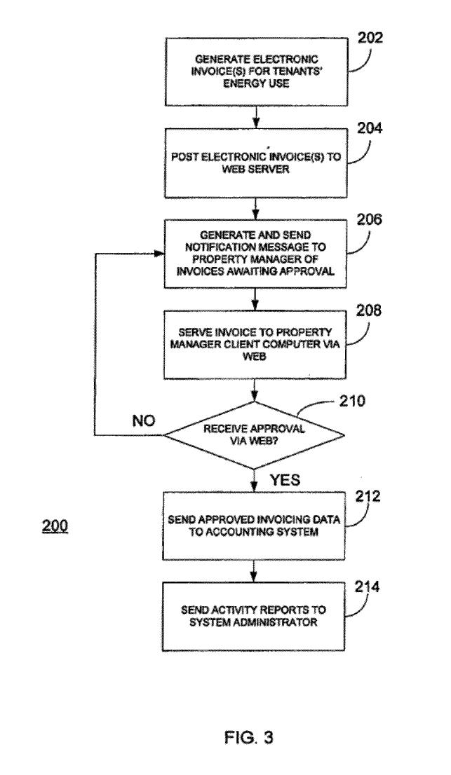

FIG. 3 illustrates a method 200 for managing building services in a building, in accordance with a web-based invoice generation, transmission and approval process. At 202, an electronic invoice is generated. The electronic invoice includes invoicing information relating to energy services usage by each of a number of tenants. The electronic invoice can be generated from a computer-implemented template that is populated with tenant data entered by a system administrator or property manager, as well as building services data obtained at the building via EMSs connected to a building optimization platform via a first communication channel. At 204, the electronic invoice is posted to a web page in a web server.

At 206, a notification message is generated and sent to a client computer associated with a property manager, for display on a user interface of the client computer. The notification message includes a notification of all current invoices that need property manager approval, and include a link or other representation of the electronic invoice for accessing the electronic invoice from the web server. If a user selects or clicks on the link, at 208 the electronic invoice is served to the client computer via the web or similar communication network. The electronic invoice includes a user-selectable approval function such as a button or link, by which the property manager can approve the invoice. Otherwise, the electronic invoice provides interactive fields for proposing an adjustment of any aspect of the electronic invoice.

At 210 the property manager can provide approval of the invoice via the web. If the property manager does not approve the invoice, the electronic invoice is stored in the web server and re-sent after a predetermined period of time, such as 10 days. If the property manager does send approval of the invoice via the web, the approved invoicing information is sent to the building owner's accounting system at 212. At 214, activity reports regarding invoicing activity are sent to the system administrator, to prevent duplicative billing and/or errors in the invoicing process.

The setup for the system can take place in a tenant manager window of a web-delivered application resident on the tenant manager's workstation, referred to as client computer 108. The application can be locally stored and executed, or remotely stored delivered from a server and then locally executed. The system allows a property manager to configure advance system settings, and create custom HVAC, plug outlet, and lighting point groups or zones within the building, in a granularity even greater than simply by floor of the building. The system further allows the property manager to create a consolidated billing list for invoice recipients, create customized reports according to portfolio of buildings for the building owner, according to building type, sorted by property manager, or by building. The system also allows the property manager to enable system security.

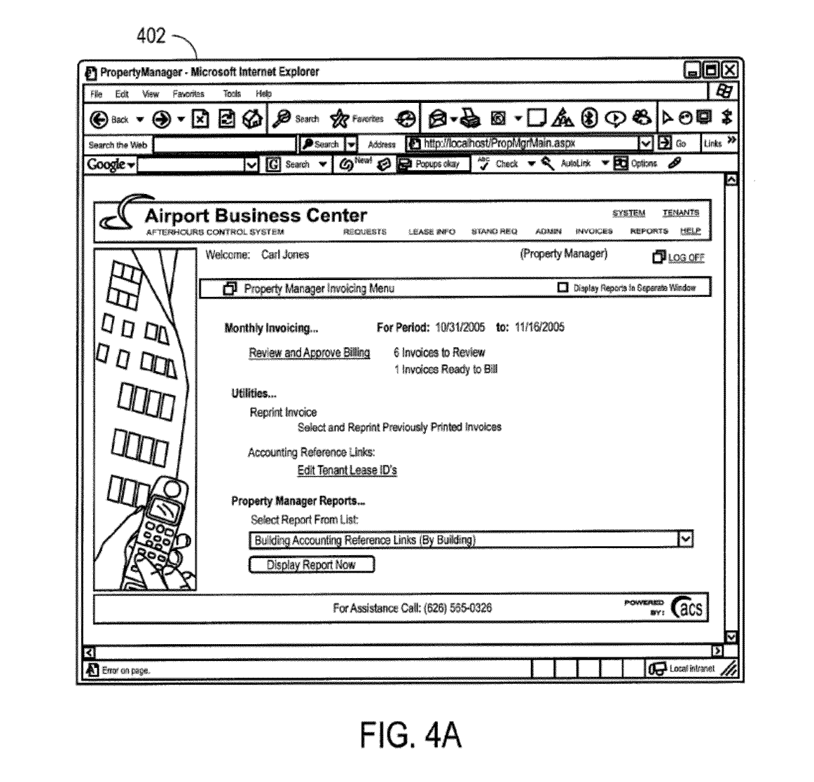

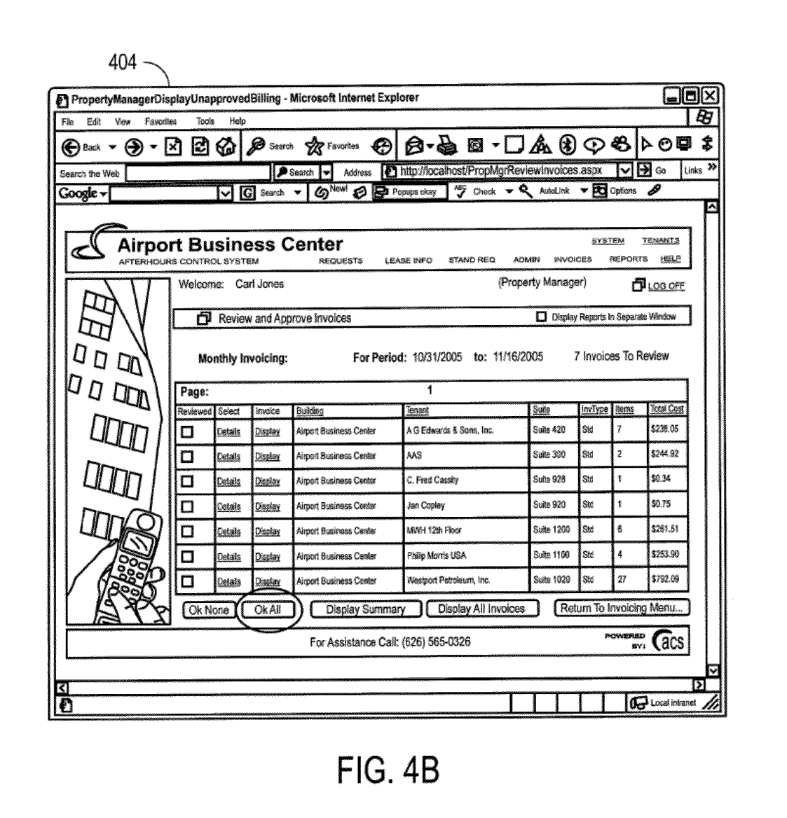

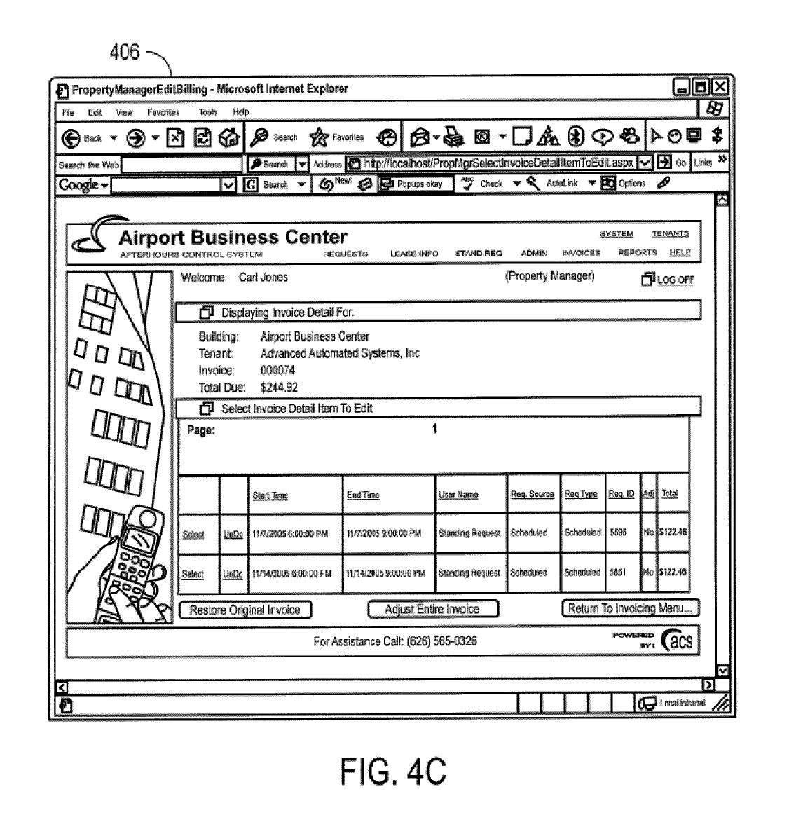

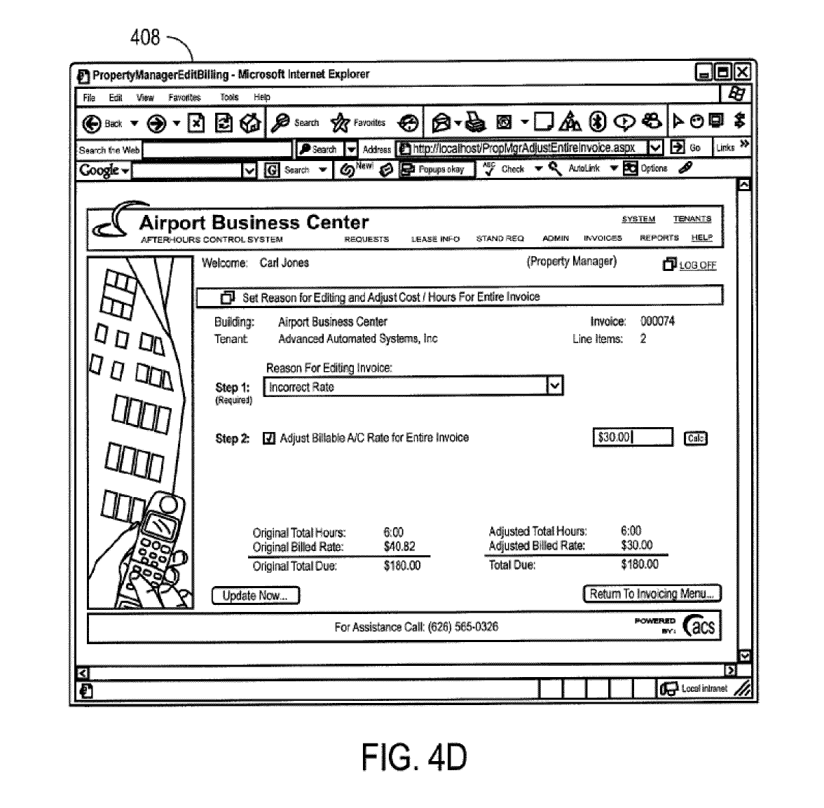

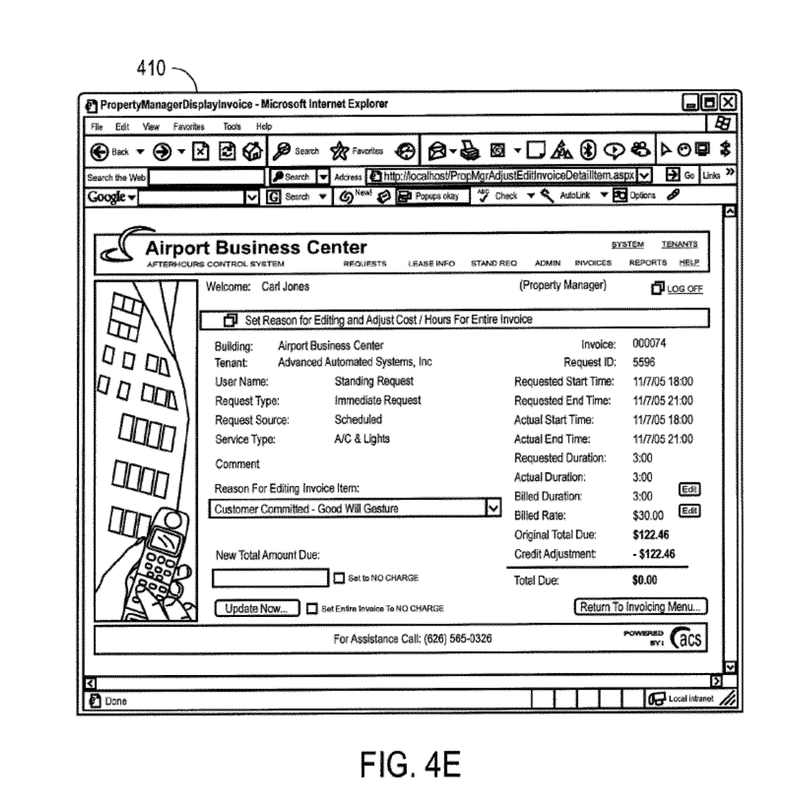

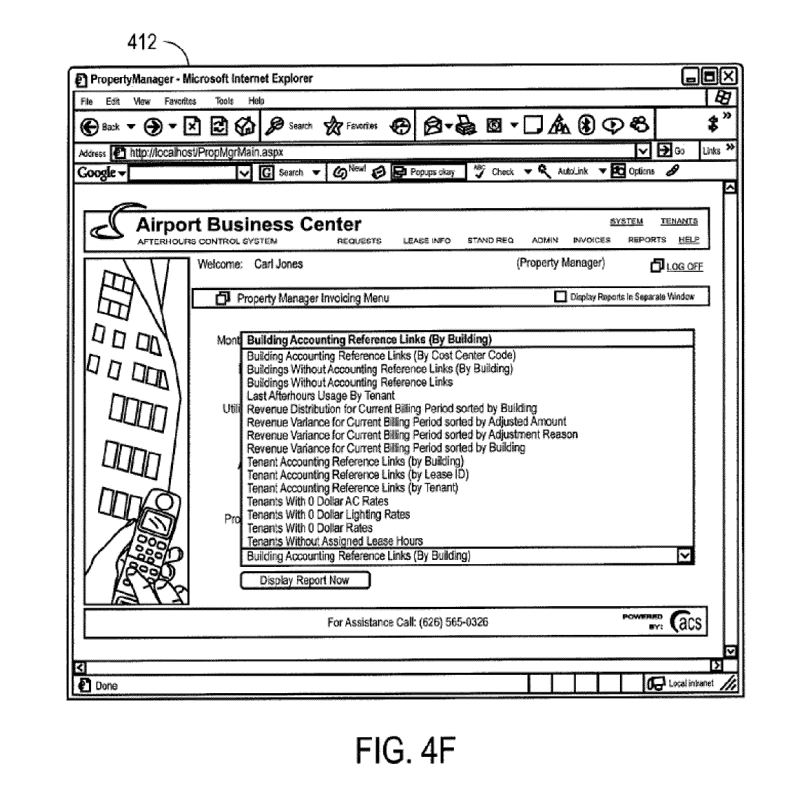

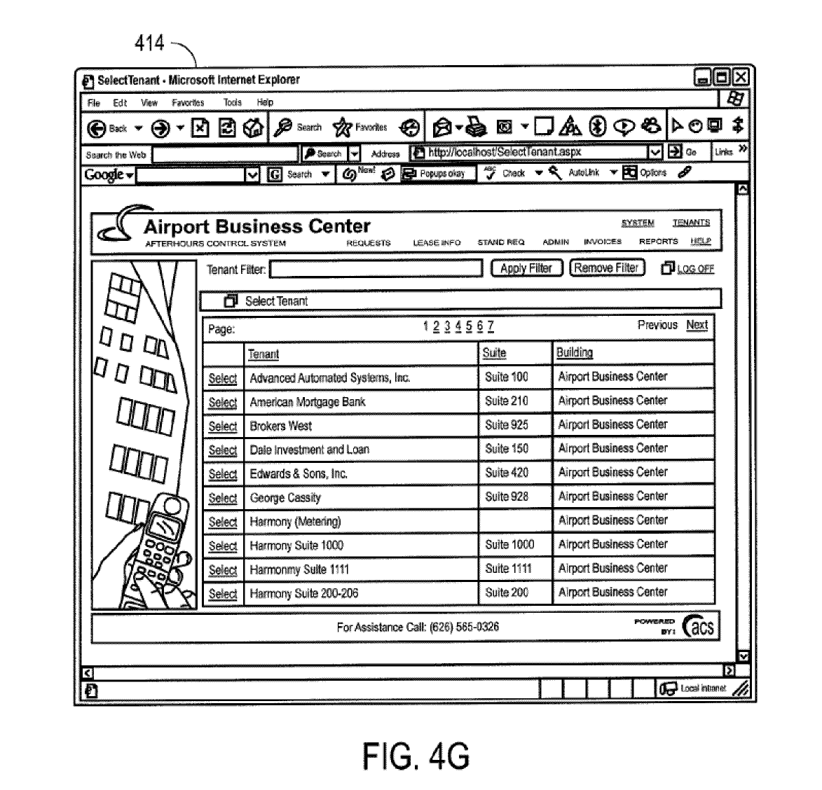

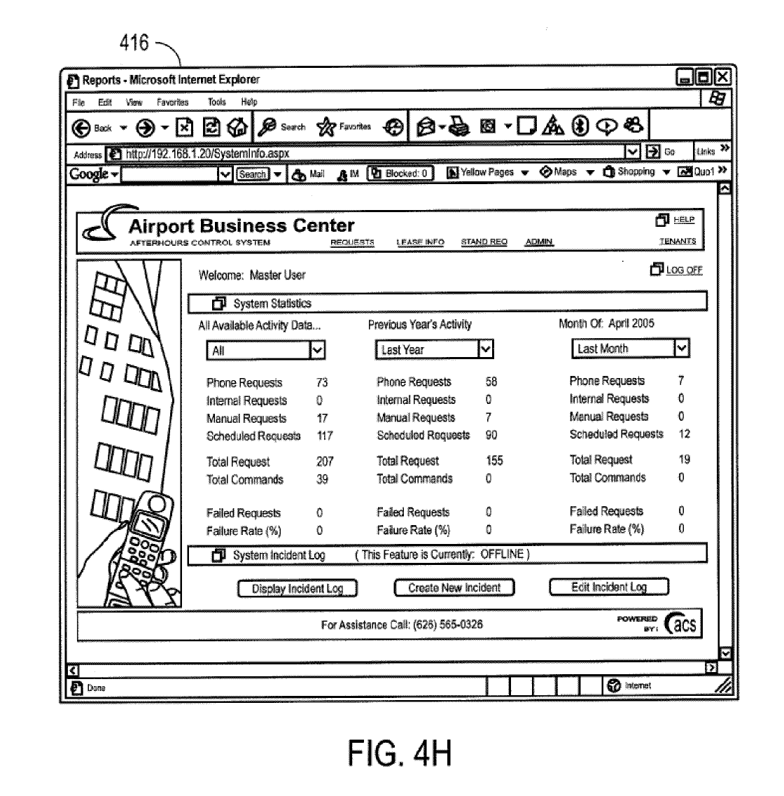

FIGS. 4A-H show various exemplary property management web pages of a website as part of a building optimization platform. In preferred implementations, the property management web pages are designed to perform two primary functions. First, through a Tenants link, property managers can perform tenant maintenance tasks, such as scheduling immediate, future and reoccurring service, cancel service and assign access rights to any tenant within their buildings. Second, at the beginning of each month, property managers review, adjust and approve the previous months billings before a data file containing the invoices are transmitted directly to accounting personnel.

The following describes a specific implementation of a web-based approval system executed by a building optimization platform, as a reference to FIGS. 4A-H:

1. At 1:00 AM on the second of each month the building optimization platform automatically generates all after hours billings and posts them directly to a website. The system will also send out an email to each property manager explaining that they have ten days to review and approve “X” amount of invoices.

2. During this ten day period, the property manager at any time can review, edit and approve after hours invoices, described in further detail below and with reference to FIGS. 4A-H. Also available to the property manager is the ability to print invoices as well as after hours income variance reports. These reports are available only as reference data only, this is due to all billing being performed automatically in a later procedure.

3. If necessary, twenty-four hours before the end of the ten day period, a second email reminder is sent explaining that there are still “X” of “Y” invoices that need approval.

4. At the end of the ten day period, all non reviewed/approved invoices are automatically marked as “approved” and will be invoiced accordingly.

5. On the tenth day of each month the building optimization platform automatically emails to accounting personnel a data file as well as a PDF file of traditional invoices containing all after hours billing information. The data file can be used to import all after hours information directly into the appropriate accounting system.

Referring now to the figures, FIG. 4A is a screenshot of an exemplary property management page 402 that can be accessed by a property manager. The property management page 402 provides a number of functions for a property manager, including functions to: approve the previous months invoices, reprint past invoices, update or set tenant lease ID numbers, and print system reports. The property management page 402 also enables functions to select a tenant for after hours setup functions, and review system activity.

For monthly invoicing functions, from the property management page 402 a user can select a “Review and Approve Billing” link or similar link, which causes a monthly invoicing approval screen 404 to appear, such as is exemplified and shown in FIG. 4B. The monthly invoicing approval screen 404 can be configured to enables billing approvals for a current billing period only. In some particular exemplary implementations, the monthly invoicing approval screen 404 is operated in the following manner:

To approve all billing without any editing, an [OK All] button is selected, or once verified, each line item as approved is checked. To undo all previous approved billings, an [OK None] button is selected. To modify a tenants invoice, the Details link can be clicked on. To display a tenants invoice, the Display link can be clicked on. To display all invoices, a [Display All Invoices] button can be clicked on. And, to display the invoice summary report, a [Display Summary] link or button is clicked on.

To view a tenants invoice detail, a [Details] link or button can be clicked on, to navigate from the monthly invoicing approval screen 404 to an invoice detail page 406 as shown in FIG. 4C. The invoice detail page 406 allows a user to adjust all invoice items by clicking on an [Adjust Entire Invoice] button. For individual line item editing, each line item can be selected by clicking on an associated link or button. This provides a property manager the control to view and edit tenant invoices in highly granular detail.

FIG. 4D shows an exemplary screenshot of an adjust entire invoice page 408, in which the user can adjust all invoice items. In some implementations, a reason for adjusting any aspect of an invoice must be provided before the user is allowed to continue. To provide the reason, the user fills out the appropriate fields—this changes depending on reason—and then selects an [Update Now] button to save changes, or clicks on an [Return to Invoice Menu] button or link to exit without saving changes. In some implementations, a [Calc] button recalculates the invoice based on the new parameters. Further, once any item has been modified, the system usage lines on a parent page, i.e. in FIGS. 4A-C, can include an indicator, such as a text or background color, to indicate the invoice has been edited. For example, system usage lines can be colored yellow to indicate edits.

FIG. 4E shows an exemplary screenshot of an adjust line item page 410 in which the user can make adjustments on a line item basis. A reason must be selected before continuing. Once the user fills out the appropriate fields, an [Update Now] button can be clicked to save changes, or a [Return to Invoice Menu] button can be clicked to exit without saving the changes. In some implementations, a [Calc] and/or an [Edit] button recalculates the invoice based on the new parameters. As with the adjust entire invoice page 408, once any item has been modified on the adjust line item page 410, the system usage lines on a parent page can include an indicator, such as a text or background color, to indicate the invoice has been edited.

FIG. 4F shows an exemplary screenshot of a property management reports page 412, having a list box of possible reports from which a user can select for any type of analytics or further processing. In preferred implementations, the user selects the desired report, then clicks on the [Display Report Now] button. The report is then displayed, using data file viewer loaded on the local client computer. In some implementations, an Adobe Postscript Datafile (PDF) format is used. Reports can be displayed in a separate window by clicking on a [Display Reports in Separate Window] check Box located on the title bar.

FIG. 4G shows an exemplary screenshot of a tenant master user page 414, which allows property managers access to all tenants defined on the system. Via the tenant master user page 414, property managers can schedule services, turn on/off services, edit tenant users, and set up standing requests for all tenants on the system. In some implementations for example, a user can click on a [Select] link or button associated with a tenant's name, and the system logs the user into that tenant's account as the master user. In some particular implementations, an aspect of the page associated with the tenant can be modified to indicate that the tenant is not set up properly on the server, such as if the tenant's name turns red when selected. A tenant name filter can be applied by typing in the first few letters of the tenant's name in a tenant filter field, such that when applied, only tenants that start with the specified filter criteria will be displayed in the [Select Tenant] window. To remove the filter setting, the user clicks on a [Remove Filter] button. In particular implementations, sorting among tenants can be achieved by clicking on any column header once for an ascending order, and twice for a descending order.

FIG. 4H shows an exemplary system page 416, which is used to track the overall system usage and performance for all buildings in a portfolio under management by the property manager or building owner. The system page includes information about numbers of requests to the system for above standard building services, and can include a number of timeframe references for comparison purposes. The request information, as well as any information provided on any page shown in FIGS. 4A-H, can be displayed in textual and/or graphical form. Further, such information can be formatted for export or transmission in any data format or according to any transmission protocol.

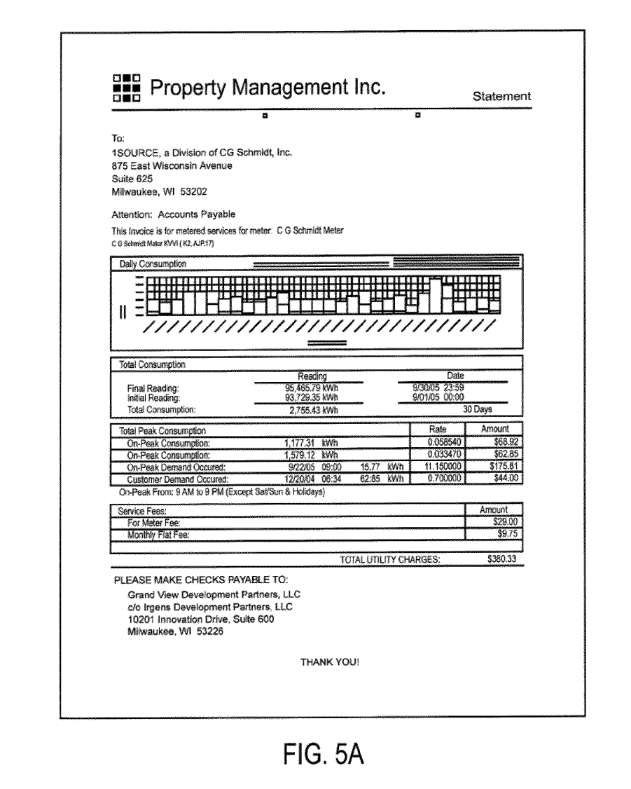

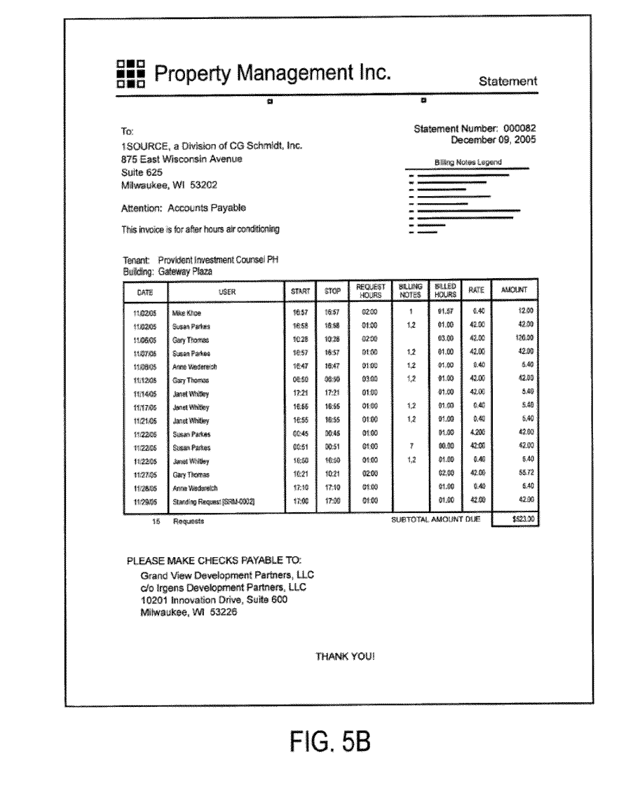

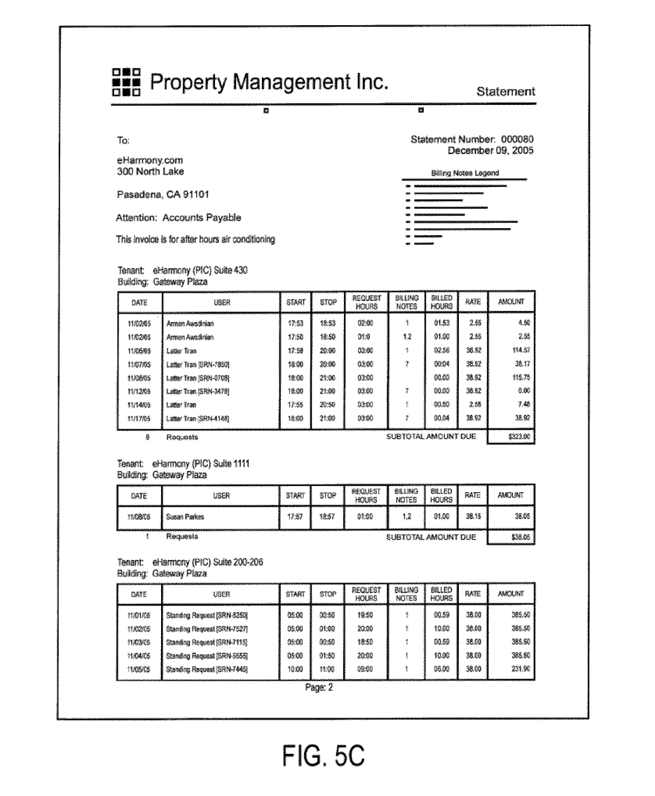

FIGS. 5A-C show exemplary statements having detailed billing information for building services such as energy usage, for example during weekends, after hours, or other above standard service usage.

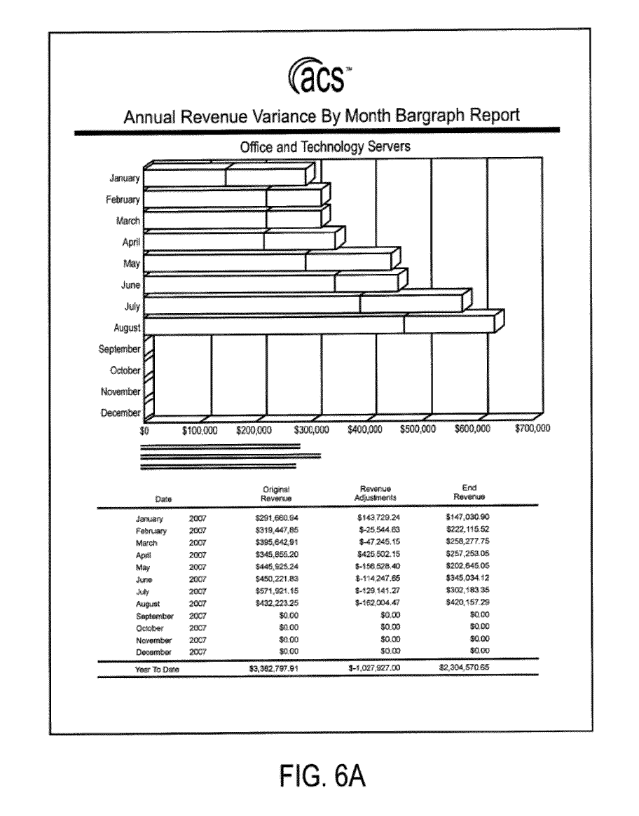

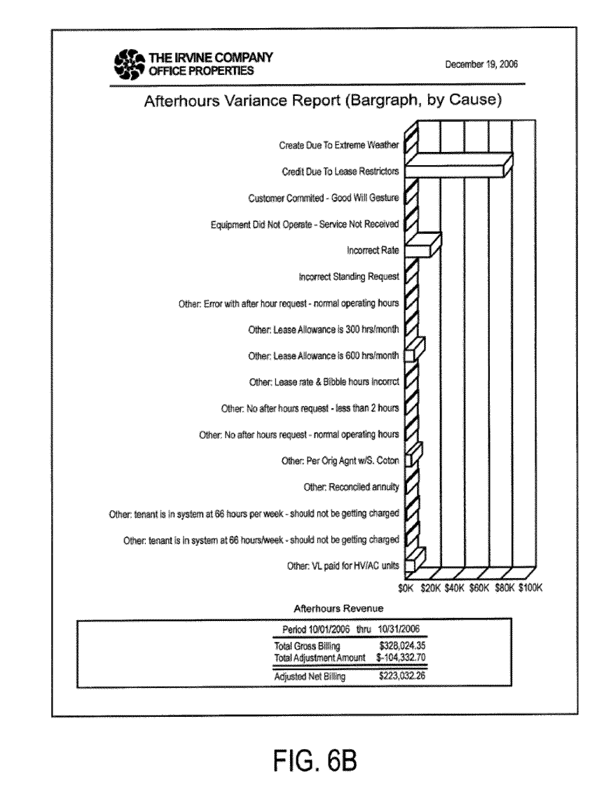

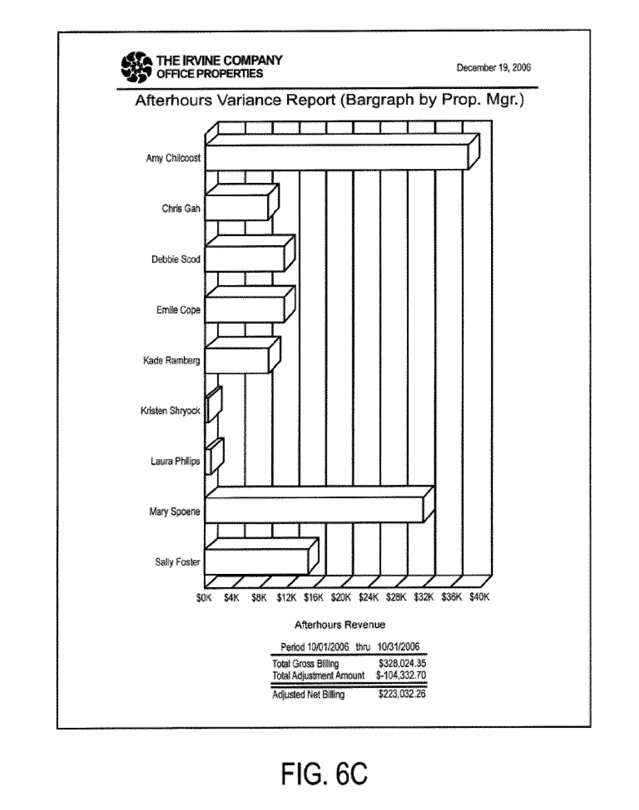

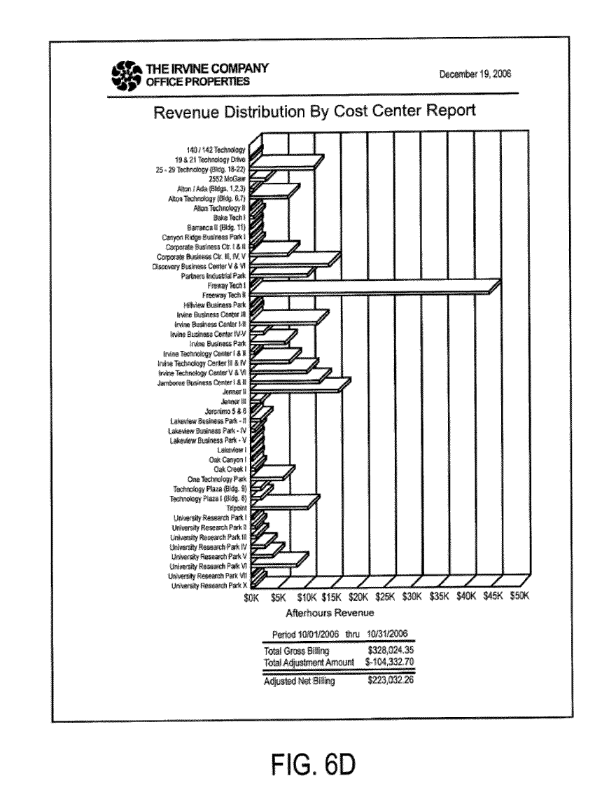

The systems and methods described herein can produce a vast amount of data about tenant energy use or building services consumption. The data can be processed by any number of business intelligence systems, for continual improvement and optimization of building services utilization and revenue optimization. One output of such business intelligence systems is shown in FIGS. 6A-D, which illustrate several variance reports that are generated through the web approval process.

FIG. 6A is an exemplary variance report, showing annual revenue variance by month, and including both a bar graph and numerical information. The dark shaded region in the bar graph represents an amount that is actually billed to the tenants, and the light shaded region represents an amount that was edited or otherwise removed from the final invoices by the property manager. This type report is shown as being processed by a portfolio, but can also be requested to be processed according to region, by company, by building type or any other grouping. FIG. 6A lists the variance according to month, but any other time frame can be shown. Further, other types of graphical depictions can be used instead of, or in conjunction with a bar graph.

FIG. 6B is another exemplary variance report, showing above-standard services variance between used services (an amount that can be billed) and actual billed. Reductions are segregated by the cause for the variance, i.e. credit for extreme weather, credit due to lease restrictions, good will, etc. This type of report can be used to isolate and focus on problematic areas that lead to high giveaways of potential revenue for the building owner, or even to provide the tenants with information that can help them improve their consumption patterns.

FIG. 6C is yet another exemplary variance report, showing variance between used services and billed-for services by property manager. Thus, this type of report can highlight those property managers who may have a particular problem, or who are too lenient in invoicing tenants for the services they request. FIG. 6D is another type of report, showing revenue distribution by cost center, such as a building or suite of buildings. The revenue is generated from the above standard service requests by the tenants of each particular cost center, as processed through the web approval process described above.

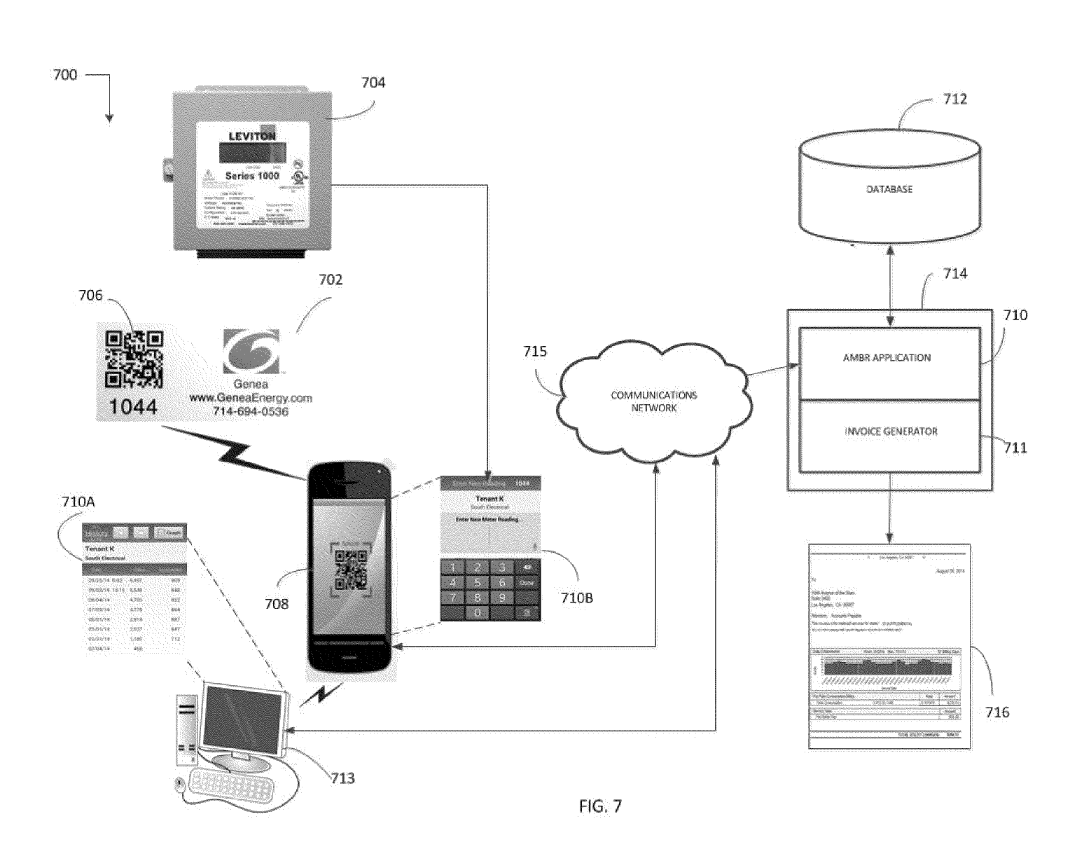

To automate and streamline collection of meter values from submeters that measure utility usage including, for example, supplemental equipment usage, an automated meter reading and billing (AMRB) system and method are disclosed. As shown in FIG. 7, an AMRB system 700 includes an asset tag 702 that is associated with each non-networked submeter 704, preferably in close proximity to a meter reading display of the submeter 704. In some implementations, the asset tag 702 is a machine-readable optical label that is fixedly attached to the submeter 704. The asset tag 702 can be a tag or sticker, and can include a machine-readable (i.e. not human-comprehensible) code 706. The machine-readable code 706 can be a QR code, a bar code, or other graphical or alphanumeric code that encodes information about the associated submeter, and/or associates the encoded information with the associated submeter. The fixed attachment can be by way of glue, screw, bolt, hook, or other attachment mechanism. In alternative implementations, the asset tag 702 can be a low-powered radio frequency (RF) transmitter such as a Bluetooth tag or RF identifier (RFID) tag.

The AMRB system 700 further includes a label or code reader 708 that can optically or electronically read or receive the encoded information from the machine-readable code 706 on the asset tag 702. In some implementations, the reader 708 can capture an image of the meter reading from the submeter's display using a built-in camera, for example. This image can be captured at or near a time when the machine-readable code 706 is read. Reader 708 can be a dedicated scanner or integrated within a mobile computing device, such as a smartphone or tablet computing device. When used as a dedicated scanner, reader 708 can transmit the encoded information to a client computer 713. The client computer 713 can be a desktop computer, a laptop computer, a smartphone, a tablet computer, and the like. Client computer 713 can run an application 710 to process the received information and display various screens and graphical user interfaces associated with the application, such as graphical user interface 710A, on the client computer. In implementations where reader 708 is integrated within a mobile computing device, the mobile computing device can execute an application 710 for processing the received information and display various screen and graphical user interfaces associated with the application, such as graphical user interface 710B. Application 710 can be locally saved and executed by client computer 713 and/or the mobile computing device 708. In some implementations, application 710 can be a distributed application that is hosted on one or more server computers 714. In these implementations, client computer 713 and/or the mobile computing device can remotely access application 710 running on server computer 714 via communications network 715.

The application 710 can receive the submeter information, either automatically or by manual entry into the reader 708 and/or application 710. The application 710 can have an interface to a data repository such as database 712 for storing the submeter information as structured data. The submeter information can include, without limitation, submeter identification or identifier, submeter characteristics or attributes, location information, information about related supplemental equipment and/or energy services for the supplemental equipment, and the like. In addition, the application 710 can also receive submeter information for non-supplemental equipment. This information can include, for example, plug load consumption, hot and/or cold water consumption, condenser water consumption, steam consumption, natural gas consumption, and the like. The type of utilities that are monitored by the submeters can vary depending on the mechanical set-up of the building in which the submeters are installed.

The submeter information also includes a meter reading or value displayed by the submeter incrementally over time, as energy services are consumed, and can include images (e.g., photographs) taken by the reader 708.

The application 710 or other program can process the submeter information from the database 712 to generate historical data, such as trends, graphs, time-based consumption patterns, etc. The application 710 or other program can also perform analytics on the submeter information to identify outlier data or possible faults or errors, or to forecast consumption patterns, for example. The application 710 is also integrated with an invoice generator 711, to automatically generate a tenant invoice 716 for the energy service consumption, based at least in part on the submeter information. The tenant invoice 716 can include one or more line items for above standard tenant services which can include, for example, utility usage associated with supplemental equipment and non-supplemental equipment. If, for example, a tenant is powering supplemental equipment in a server room, then application 710 can monitor the associated energy consumption, and invoice generator 711 can bill the tenant for the same. The submeter, in combination with application 710, can also monitor utility usage by non-supplemental equipment. For example, a tenant's lease can specify a maximum allowance of plug load usage or natural gas usage during predetermined lease hours. Outside of these hours, these allowances can be adjusted (e.g., decreased or set to zero). Application 710 can monitor utility usage both during and after lease hours and track any usage that exceeds the thresholds specified in the lease. These above standard tenant service can be billed to the tenant.

The invoice generator 711 can deliver the tenant invoice 716 electronically over a network, such as an electronic mail system or via a webpage, or can send the tenant invoice to a printer or other hardcopy generator for delivery to the tenant. The database 712 stores historical invoices, graphs, photographs, readings or measurements, etc.

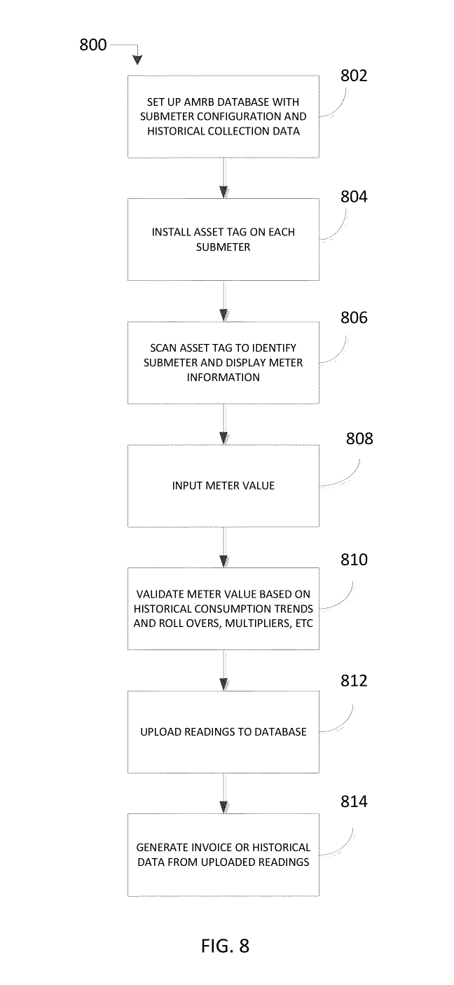

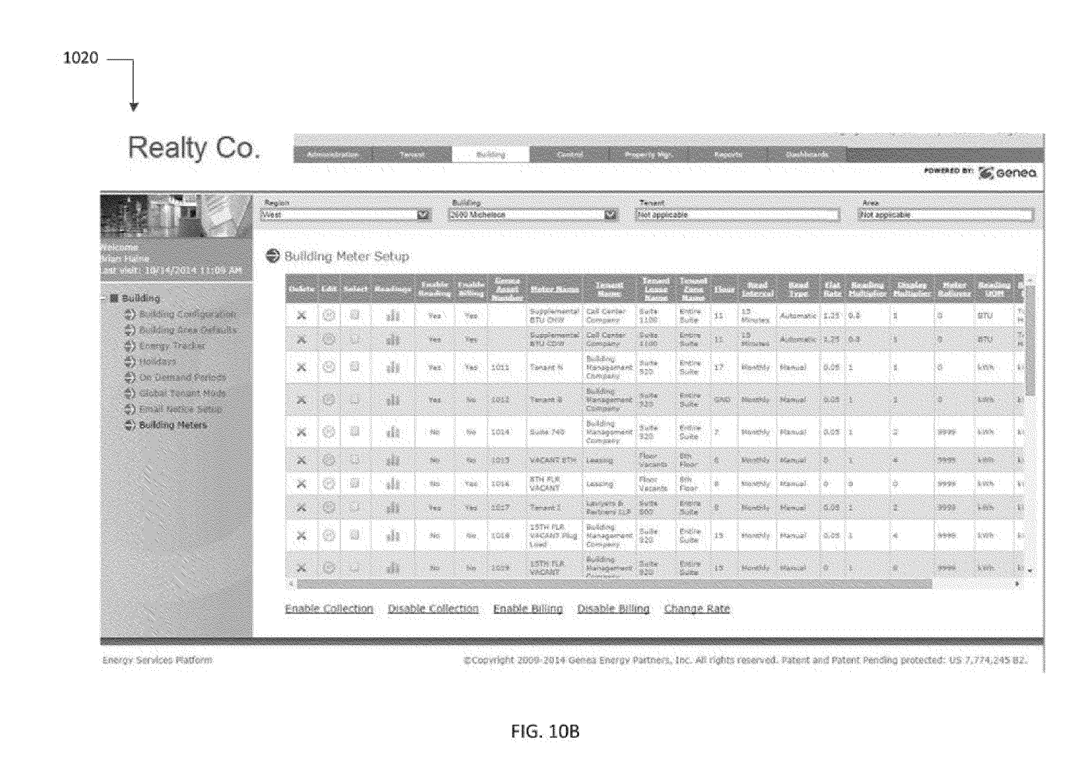

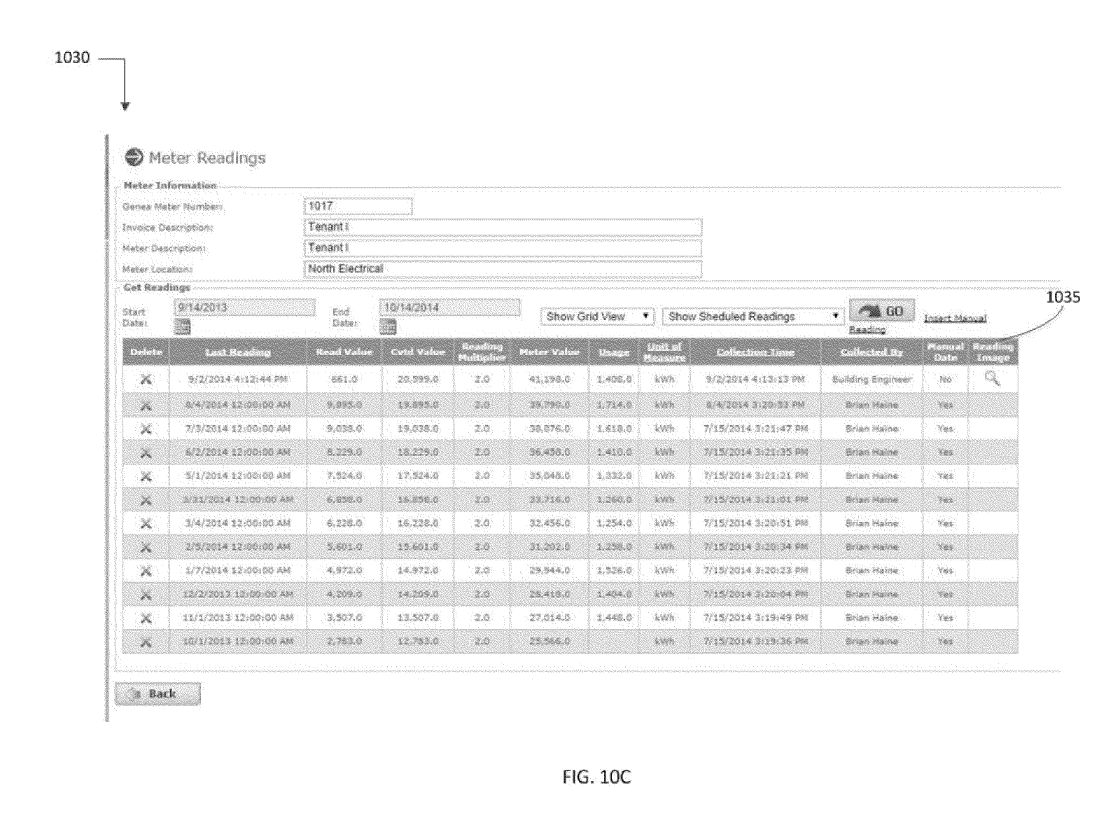

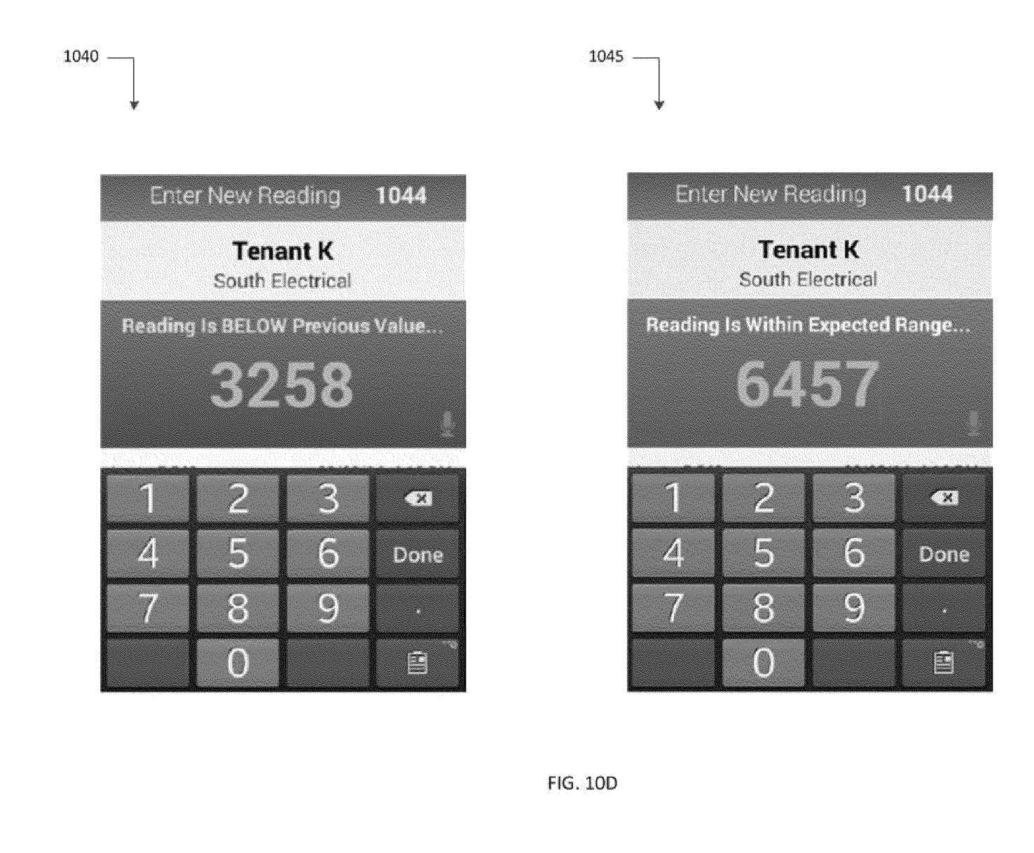

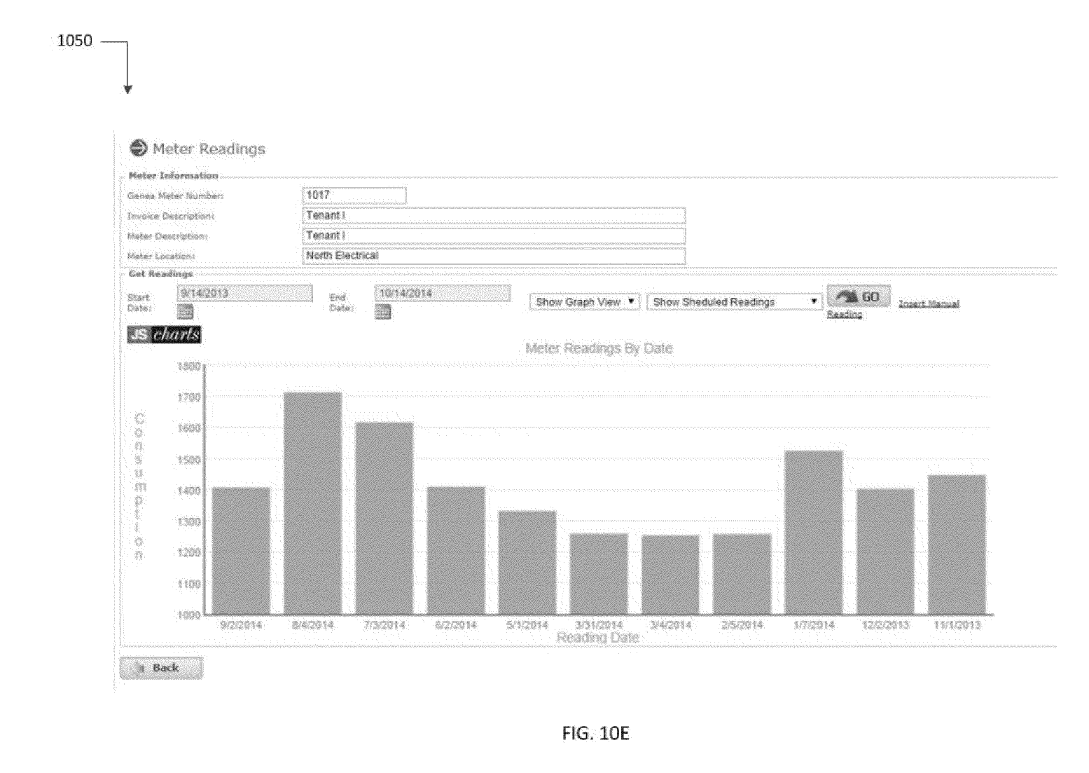

FIG. 8 illustrates a method 800 for automated meter reading and billing, in accordance with implementations described herein. At 802, an AMRB database 712 is set up for each submeter with submeter configuration data. These submeters can be connected to supplemental equipment or non-supplemental equipment. FIG. 10A illustrates a graphical user interface 1000 that can be used to enter configuration information for each submeter in a building. The configuration data can include submeter identification information 1002, meter properties 1004, billing properties 1006, and optional notes 1008 to provide additional information. FIG. 10B illustrates a graphical user interface 1020 that displays configuration data for all of the submeters in a particular building or address. The information displayed in graphical user interface 1020 can provide a visual snapshot of all of the registered meters in the building. The information in this visual snapshot can facilitate comparison of various types of configuration data for the submeters in the building. In addition, a particular submeter's configuration data can be selected for further editing from graphical user interface 1020. The AMRB database 712 can also store historical data for submeters including, for example, a history of collection data. FIG. 10C illustrates a graphical user interface 1030 that displays historical meter readings for a particular submeter in an exemplary implementation. This historical data can include, for example, a day and/or time when the meter was last read, the read value, the meter value, and the like. This historical data can also include images 1035. As described below with respect to process 808, an image of a meter reading can be captured and saved to the AMRB database 712 for later viewing.

At 804, an asset tag is installed on or with the submeter. As described above, the asset tag can be a machine-readable optical label that is fixedly attached to the submeter. As such, the asset tag can be a tag or sticker, and can include a machine-readable (i.e. not human-comprehensible) code. The machine-readable code can be a QR code, a bar code, or other graphical or alphanumeric code that encodes information about the associated submeter and/or associates the encoded information with the associated submeter. The fixed attachment can be by way of glue, screw, bolt, hook, or other attachment mechanism. In alternative implementations, the asset tag can be a low-powered radio frequency (RF) transmitter such as a Bluetooth tag or RF identifier (RFID) tag.

In an operational scenario, at 806 the asset tag is scanned by a reader or scanner 708 to identify the submeter as established at 802, and an image of display meter information 1002 and/or meter properties 1004 is also generated The reader or scanner can be implemented in a mobile computing device, such as a smartphone or tablet computer, or can be a standalone device such as a handheld scanner or reader, which can in turn be connected electrically or wirelessly with a computing device 713.

At 808, a meter value, as displayed or generated by the submeter, is input into the mobile computing device 708 or an application running on a computing device 713. The meter value can be received by manual user input, i.e. by manipulation of a keyboard, keypad or touch screen display, or by voice command, optical reader, scanner, or the like. In some implementations, an image capture device can capture an image of the meter reading. These images can be captured in accordance with a predetermined schedule, such as during normally scheduled meter readings as specified by meter properties 1004. Additionally or alternatively, these images can be captured on demand. The image capture device can be, for example, a mobile computing device 708, a camera, a recorder that records an audible indication of the meter reading (e.g., a recording of the meter clicks), and the like. The camera and/or recorder can be attached to or integrally incorporated with the submeter. The image of the meter reading can be transmitted to the AMRB application 710 and saved to database 712. In some implementations, a timestamp representative of the date and time at which the image is taken can also be saved to database 712. In some implementations, optical character recognition software associated with AMRB application 710 can be used to convert the image of the meter reading into an alphanumeric value. As described above with respect to FIG. 10C, these images can be retrieved from graphical user interface 1030 by selecting the desired reading from column 1035. These images can be used for auditing purposes. For example, if an operator manually enters a meter reading into the AMRB application at 808, a billing administrator can later verify that this reading was correctly entered by comparing it to an image of the meter reading. In some implementations, this comparison may be done on an automated basis by AMRB application 710 when invoices are generated.

At 810, the meter value is validated. The validation can be based on any of historical consumption trends, rollovers, multipliers, etc., and/or association to identification information of the associated submeter. In some implementations, the validation can be processed by an application running on a computing device, such as mobile computing device 708. The application logic can determine whether the consumption value associated with the reading is out of scope, such as below a previously recorded value or too high with respect to historical readings.

A reading may be too high if, for example, the consumption value associated with the reading is greater than a specified limit or if the consumption value is some multiplier greater than one or more historical consumption values associated with historical readings (e.g., more than twice the consumption value associated with the previous historical reading, more than twice the average of the last five consumption values associated with the last five readings, etc.). In some implementations, the reading may be too high if the consumption value associated with the reading is some multiplier greater than the highest consumption value over a historical period. The historical period can be any number of immediately preceding weeks, months, and the like. In some implementations, the historical period can include preceding weeks, months, and the like in previous years (e.g., a reading and its corresponding consumption value taken in December of 2014 may be compared to historical readings and corresponding consumption values taken in December of 2011, December of 2012, and December of 2013). This historical data can be locally stored and accessed by mobile computing device 708 or remotely accessed at database 712 via communications network 715.

The application logic can also determine whether the reading is valid or in scope, such as being in line with historical trends or expected values. The trends and expected values can be configurable in the application logic and calculated from historical meter reading values and their corresponding consumption values.

In some implementations, the application logic can account for submeter rollovers when determining whether a reading is in scope. For example, if a particular submeter's previous reading value is 997 and the current reading value is 30, then the application logic can determine that the submeter value has rolled over and that the current consumption is 33. Whether a submeter has a rollover setup can be indicated in graphical user interface 1000 and checked by the application logic. The application logic can compare the current consumption with one or more historical consumption values to determine whether the reading is in scope. Additionally or alternatively, if a particular submeter has a multiplier associated with it, the application logic can use this multiplier value to determine the meter reading value.

FIG. 10D illustrates a graphical user interface 1040 having an out of scope meter reading value. In this implementation, the meter reading value is out of scope because it is below a previous meter reading value. An out of scope reading can result in a generation of a first notification type, such as rendering a portion of graphical user interface 1040 in a red color or displaying other graphical indicia to indicate that the reading is out of scope. In some implementations, the graphical user interface 1040 can be displayed in a yellow color or display a graphical indicia to indicate that the out of scope reading is substantially close to the previous meter reading value. An out of scope reading may be substantially close to a previous meter reading value if, for example, its value is within a predetermined percentage (e.g., within 5%, 10%, and the like) of the previous meter reading value.

FIG. 10D also illustrates a graphical user interface 1045 having an in scope meter reading value. An in scope reading can cause the application logic to generate a second notification type, such as rendering a portion of graphical user interface 1045 in a green color or displaying other graphical indicia to indicate that the reading is in scope.

At 812, the readings are uploaded or otherwise transmitted to an AMRB database 712. These readings can be transmitted across communications network 715 or by directly syncing mobile computing device 708 or client computer 713 with database 712. The database 712 can provide access to historical data, which can be processed to generate historical data such as a utilization bar chart over time as illustrated in graphical user interface 1050 of FIG. 10E. In some implementations, graphical user interface 1050 can present this information in other formats, such as a table that provides numerical representations of energy services usage and the like.

At 814, the readings and other data can be processed to generate a tenant invoice 716 for the energy services used, based on the metered data and meter values. Historical data can also be used, as well as any of a number of parameters employed by a computing device that generates the invoice 716. These parameters can include tiered rate billing, peak demand rate billing, and the like.

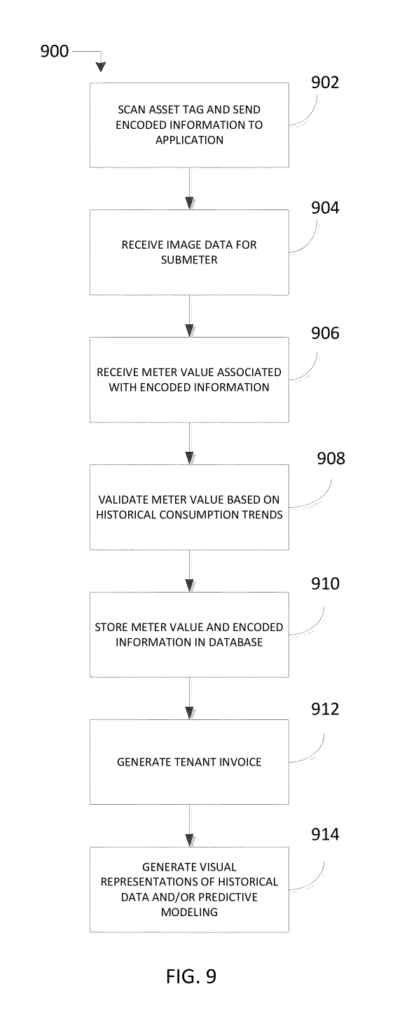

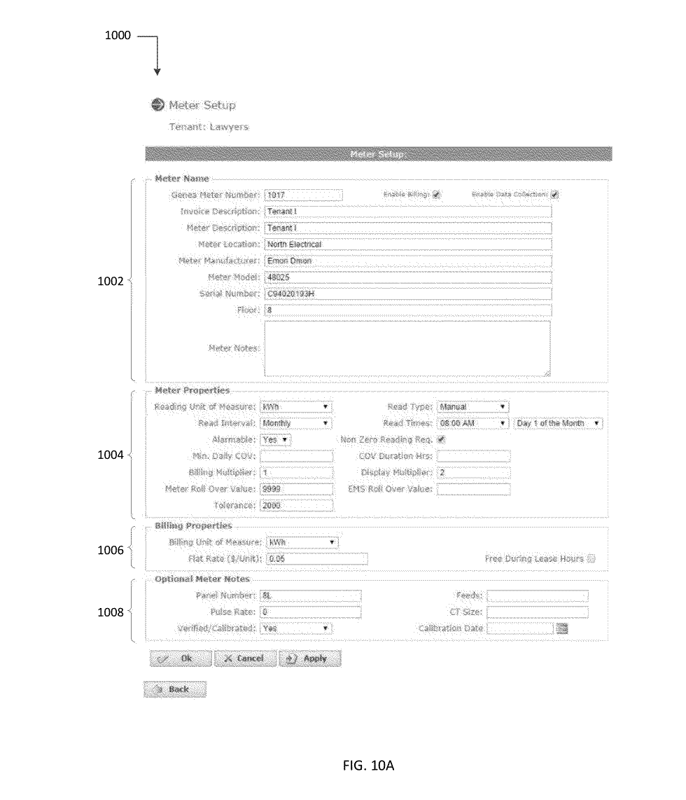

FIG. 9 illustrates a method 900 for automated meter reading and billing as executed and implemented by a computer. The method 900 automates meter reading and billing to tenants, to streamline the billing and collections cycle for recovering energy services usage costs for a utility service. The utility service can include, for example, supplemental equipment usage, plug load usage, hot and/or cold water usage, condenser water usage, steam usage, natural gas usage, and the like by the tenants. At 902, a scan is made of an asset tag 702 that is associated with a non-networked submeter that meters any kind of utility service as described above. The asset tag preferably includes encoded information in the form of a graphical code 706, such as a bar code or QR code. The encoded information is scanned and received by an application 710 executed by a mobile computing device 708 or client computer 713. The application 710 can have a scanning module, a receiving module, and one or more data processing modules. At 904, the mobile computing device 708 or client computer 713 receives image data of the submeter. The image data may be captured by a camera associated with the mobile computing device 708, or may be captured by a remote camera or image capture device associated with the submeter. The image data for the submeter can include any combination of the information included in graphical user interface 1000.

At 906, a meter value is received by the application 710. The meter value can be collected manually by a user of the mobile computing device 708, or can be automatically discerned from an image capture operation, a scanning operation, or the like. Process 906 can proceed in a similar manner as process 808. Accordingly, the meter value can be collected as an input from a keypad, touchscreen display, voice command, scanner, and the like. An image capture device, such as a camera or recorder that records an audible indication of the meter reading, can also be used as described above with respect to process 808. While the submeter is typically non-networked, i.e., not having communication capability, in some implementations the meter value can be received via wireless transmission such as Bluetooth or other RF transmission by the submeter, such as by an RFID tag associated with the submeter. At 908, application 710 validates the meter value using historical consumption and historical patterns data stored at database 712 and/or predictive calculations. The validation performed at process 908 can proceed in a similar manner as process 810.

At 910, the computer stores the meter value in a database 712. The computer can also store the information from the encoded information of the asset tag. The information in the database can be in any format or configuration, such as a relational database, etc. The information in the database 712 can be accessed by any number of specific-purpose computing machines to perform any type of processing on the information, including data visualization (such as graphing data usage over time), analytics, or predictive modeling.

At 912 an invoice generation module associated with the application generates a tenant invoice 716 based at least in part on the encoded information and meter value(s).

At 914, the computer generates a visual representation of historical data and/or predictive modeling. The visual representation can be configured to only include current invoices, or can generate a graphical representation of a series of usage and/or billed data over time. The visual representation can be transmitted and deployed in a graphical user interface or sent to various recipients via an electronic medium, such as a document transmission or electronic mail.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A system comprising:
an asset tag that is physically associated with a submeter that is not connected with a communication network, the submeter configured to track and measure consumption of a utility service associated with a tenant occupying at least part of a building in accordance with a lease covering at least some utility service used by the tenant as part of standard tenant services, the consumption of the utility service being an instance of a tenant-incurred cost of above standard tenant services use, the tenant-incurred cost being determined based on usage data in excess of that covered by the lease in the at least part of the building, the asset tag having an encoded representation of the physically associated submeter;
a mobile computing device having a reader for reading the encoded representation of the physically associated submeter within the at least part of the building, and for receiving an input signal representing a meter reading of the associated submeter based on the measured consumption of the utility service by the submeter; and
an application for execution on the mobile computing device, the application receiving an identity of the associated submeter and the meter reading of the associated submeter and determining whether the meter reading is valid based on a comparison of the consumption associated with the meter reading with one or more historical consumption values.

2. The system of claim 1, wherein the application is further configured to display a user notification based on the determining.

3. The system of claim 1, wherein the application is further configured to store the meter reading in a database having the one or more historical meter reading values.

4. The system of claim 1, wherein the application is further configured to generate a visual representation of the one or more historical meter reading values.

5. The system of claim 1, wherein the utility service is associated with one or more of supplemental equipment usage, plug load usage, water usage, steam usage, and natural gas usage.

6. The system of claim 1, wherein the application is further configured to receive an image for the meter reading and save the image to a database, the image used to audit the meter reading.

7. The system of claim 1, wherein the meter reading of the associated submeter is used to generate an invoice for the consumption of the utility service as tracked and measured by the submeter.

8. The system of claim 1, wherein the asset tag includes a machine-readable indicia selected from one or more of a QR code, a bar code, a graphical code, and an alphanumeric code.

9. A computer-implemented method comprising:
receiving an input signal representing an identity of a submeter that is not connected with a communication network, the submeter configured to track and measure consumption of a utility service associated with a tenant occupying at least part of a building in accordance with a lease covering at least some utility service used by the tenant as part of standard tenant services, the consumption of the utility service being an instance of a tenant-incurred cost of above standard tenant services use, the tenant-incurred cost being determined based on usage data in excess of that covered by the lease in the at least part of the building;
receiving a meter reading of the submeter; and
determining whether the meter reading is valid based on a comparison of the consumption associated with the meter reading with one or more historical consumption values.

10. The computer-implemented method of claim 9, wherein the submeter is physically associated with an asset tag having an encoded representation of the identity of the submeter, and
wherein the asset tag includes a machine-readable indicia selected from one or more of a QR code, a bar code, a graphical code, and an alphanumeric code.

11. The computer-implemented method of claim 9 further comprising:
displaying a user notification based on the determining.

12. The computer-implemented method of claim 9 further comprising:
storing the meter reading in a database having the one or more historical meter reading values.

13. The computer-implemented method of claim 9 further comprising:
generating a visual representation of the one or more historical meter reading values.

14. The computer-implemented method of claim 9, wherein the utility service is associated with one or more of supplemental equipment usage, plug load usage, water usage, steam usage, and natural gas usage.

15. The computer-implemented method of claim 9 further comprising:
receiving an image for the meter reading; and
saving the image to a database, the image used to audit the meter reading.

16. The computer-implemented method of claim 9, wherein the meter reading of the associated submeter is used to generate an invoice for the consumption of the utility service as tracked and measured by the submeter.

17. A non-transitory computer-readable medium containing instructions to configure at least one processor to perform operations comprising:
receiving an input signal representing an identity of a submeter that is not connected with a communication network, the submeter configured to track and measure consumption of a utility service associated with a tenant occupying at least part of a building in accordance with a lease covering at least some utility service used by the tenant as part of standard tenant services, the consumption of the utility service being an instance of a tenant-incurred cost of above standard tenant services use, the tenant-incurred cost being determined based on usage data in excess of that covered by the lease in the at least part of the building;
receiving a meter reading of the submeter; and
determining whether the meter reading is valid based on a comparison of the consumption associated with the meter reading with one or more historical consumption values.

18. The non-transitory computer-readable medium of claim 17, wherein the submeter is physically associated with an asset tag having an encoded representation of the identity of the submeter, and
wherein the asset tag includes a machine-readable indicia selected from one or more of a QR code, a bar code, a graphical code, and an alphanumeric code.

19. The non-transitory computer-readable medium of claim 17, the operations further comprising:
displaying a user notification based on the determining.

20. The non-transitory computer-readable medium of claim 17, the operations further comprising:
receiving an image for the meter reading; and
saving the image to a database, the image used to audit the meter reading.

21. The non-transitory computer-readable medium of claim 17, wherein the meter reading of the associated submeter is used to generate an invoice for the consumption of the utility service as tracked and measured by the submeter.
